(19) United States
(12) Patent Application Publication
(10) Pub. No.: US 2019/0005908 A1
(43) Pub. Date: Jan. 3, 2019

(54) METHOD FOR CORRECTING AND ADJUSTING A GAMMA CURVE AND DISPLAY DEVICE

(71) Applicants: HKC Corporation Limited, Shenzhen, Guangdong (CN); Chongqing HKC Optoelectronics Technology Co., Ltd., Chongqing (CN)

(72) Inventor: Yu-Jen Chen, Chongqing (CN)

(21) Appl. No.: 16/064,000

(22) PCT Filed: May 10, 2017
(86) PCT No.: PCT/CN2017/083804

§ 371 Date: Jun. 19, 2018

(30) Foreign Application Priority Data
Dec. 15, 2016 (CN) 201611161378.5

(51) Int. Cl. G09G 3/36; G09G 3/34

(52) U.S. Cl. CPC G09G 3/3648; G09G 2320/0673; G09G 3/3406; G09G 3/3607

(57) ABSTRACT

A method for correcting and adjusting a gamma curve and a display device are provided. The method includes the steps of predetermining a plurality of different gamma curves in a display panel, wherein each of the gamma curves corresponds to a time range; obtaining an accumulated operating time of the display panel; selecting a corresponding one of the gamma curves according to the time range corresponding to the accumulated operating time; and controlling an operation of the display panel according to the selected gamma curve.

### FIELD OF THE INVENTION

The present invention relates to an electronic technique, and more particularly to a method for correcting and adjusting a gamma curve and a display device.

### BACKGROUND OF THE INVENTION

TFT LCDs (thin film field-effect transistor LCD) use an external light source to illuminate the pixels. The pixels are used to control the transmittance T of the luminous energy to determine the brightness of the pixels. A gamma curve is taken as a proportional relationship between an input signal and an output brightness. The gamma curve plays an important role in the display effect of the display device. The transmittance T as an indicator of the output brightness is mainly controlled by the magnitude of an applied voltage. The applied voltage is an input signal. However, the main factors affecting the magnitude of the transmittance T, in addition to the voltage, include the material properties of the pixel. The materials affecting the pixels include a light guide plate, a glass substrate, a liquid crystal, a color filter, and a polarizer. TFT LCD products have a fixed transmittance T, namely, a fixed gamma curve. After a long period of time, the aging of the material itself will change the properties, and the transmittance T will be changed accordingly. As a result, the gamma curve of the TFT LCD display panel will generate a deviation.

TFT LCD products have a fixed transmittance T, namely, a fixed gamma curve. After a long period of time, the aging of the material itself will change the properties, and the transmittance T will be changed accordingly. As a result, the gamma curve of the TFT LCD display panel will generate a deviation.

Gamma 2.2 is deemed as the best curve for the human eyes to feel changes in gray scale. But, the material after a long period of time will produce an irreversible aging phenomenon. At this time, the properties of the gamma curve will be slightly changed, that is, the transmittance and the gamma curve will also deviate. With the increase in time, the deviation will increase and the image of the TFT LCD will be more and more distortion. It is necessary to correct the gamma curve for solving the problems of a color cast, abnormal brightness, and other issues.

### SUMMARY OF THE INVENTION

The primary object of the present invention is to provide a method for correcting and adjusting a gamma curve and a display device. A gamma curve suitable for the current state of a display panel can be selected timely to obtain the best image effect, thereby enhancing the viewing experience of the user.

According to one aspect of the present invention, a method for correcting and adjusting a gamma curve is provided. The method comprising: predetermining a plurality of different gamma curves in a display panel, wherein each of the gamma curves corresponds to a time range; obtaining an accumulated operating time of the display panel; selecting a corresponding one of the gamma curves according to the time range corresponding to the accumulated operating time; and controlling an operation of the display panel according to the selected gamma curve.

According to another aspect of the present invention, a display device is provided. The display device comprises: a display panel; a memory unit, used for storing program instructions; and a processing unit, connected with the display panel and the memory unit, used for calling and executing the program instructions to perform the following steps: predetermining a plurality of different gamma curves in a display panel, wherein each of the gamma curves corresponds to a time range; obtaining an accumulated operating time of the display panel; selecting a corresponding one of the gamma curves according to the time range corresponding to the accumulated operating time; controlling an operation of the display panel according to the selected gamma curve.

According to a further aspect of the present invention, a display device is provided. The display device comprises: a display panel; a first predetermining unit, used for predetermining a plurality of different gamma curves in a display panel, wherein each of the gamma curves corresponds to a time range; a first obtaining unit, used for obtaining an accumulated operating time of the display panel; a selection unit, used for selecting a corresponding one of the gamma curves according to the time range corresponding to the accumulated operating time; and a control unit, used for controlling an operation of the display panel according to the selected gamma curve.

The embodiments of the present invention can timely select a gamma curve suitable for the current state of the display panel to obtain the best image effect, thereby improving the quality of the display panel and enhancing the viewing experience of the user.

### BRIEF DESCRIPTION OF THE DRAWINGS

These and/or other aspects will become apparent and more readily appreciated from the following description of the embodiments, taken in conjunction with the accompanying drawings, in which:

FIG. 1 is a flow chart of a method for correcting and adjusting a gamma curve in accordance with an embodiment of the present invention;

FIG. 2 is a sub flow chart of step S102 in FIG. 1;

FIG. 3 is a sub flow chart of step S103 in FIG. 1;

FIG. 4 is a flow chart of a method for correcting and adjusting a gamma curve in accordance with another embodiment of the present invention;

FIG. 5 is a block diagram of a terminal in accordance with an embodiment of the present embodiment;

FIG. 6 is a sub block diagram of the first obtaining unit 102 of FIG. 5;

FIG. 7 is a sub block diagram of the selection unit 103 of FIG. 5;

FIG. 8 is a block diagram of a terminal in accordance with another embodiment of the present embodiment;

FIG. 9 is a block diagram of a display device in accordance with an embodiment of the present embodiment; and

FIG. 10 is a block diagram of a terminal in accordance with a further embodiment of the present embodiment.

### DESCRIPTION OF ILLUSTRATED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

It will be further understood that the terms “comprises,” “comprising,” “includes,” and “including,” when used in this specification and the attached claims, specify the presence of the stated features, integers, steps, operations, elements, and/or components, but do not preclude the presence or addition of one or more other features, integers, steps, operations, elements, components, and/or groups thereof.

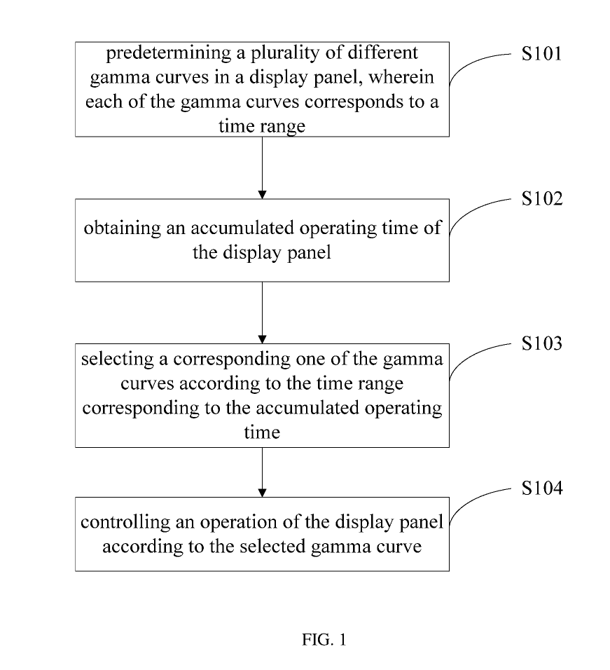

FIG. 1 is a flow chart of a method for correcting and adjusting a gamma curve in accordance with an embodiment of the present invention. As shown in FIG. 1, the method may comprise the following steps of:

Step S101, a display panel is set with a plurality of different gamma curves. Each gamma curve corresponds to a time range.

Wherein, because the gamma curve of the display panel will deviate correspondingly over time, in order to ensure the display effect of the display panel, it is necessary to set a plurality of different gamma curves in the display panel and to select a corresponding one of the gamma curves within a specific time range for gamma correction and adjustment.

Step S102, an accumulated operating time of the display panel is obtained.

Wherein, the gamma curves of the display panel are related to the material properties of the display panel. When the material of the display panel is aged, the gamma curve currently applied to the display panel will deviate. The aging speed of the display panel is related to the operating time of the display panel. It is necessary to measure the accumulated operating time of the display panel.

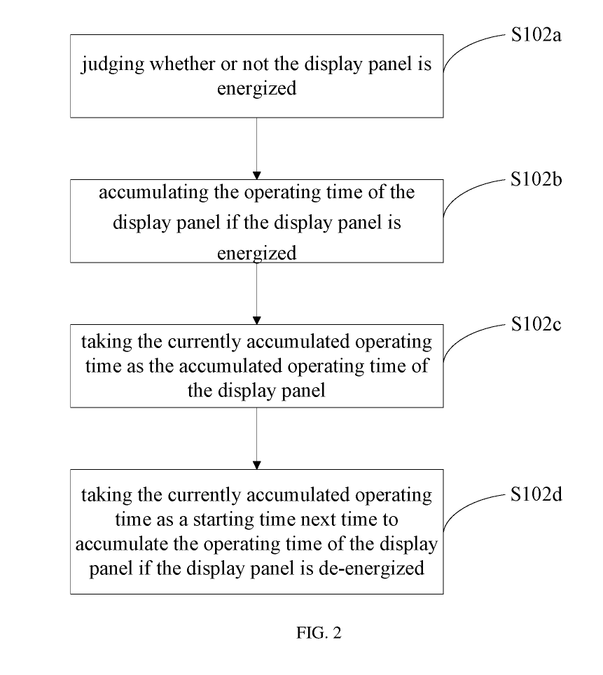

Preferably, FIG. 2 is a sub flow chart of step S102 in FIG. 1. Step S102 specifically includes the following steps of:

Step S102a, it is judged whether or not the display panel is energized. The display panel is powered by an external power supply. When the display panel is energized, the display panel is considered to start working.

Step S102b, if the display panel is energized, the operating time of the display panel is accumulated. When the display panel is energized to start working, the previous operating time of the display panel is fully accumulated to obtain a total accumulated time.

Step S102c, the currently accumulated operating time is taken as the accumulated operating time of the display panel.

Step S102d, if the display panel is de-energized, the currently accumulated operating time is taken as the starting time next time to accumulate the operating time of the display panel.

Wherein, the aging of the material of the display panel is related to the total operating time of the display panel. When the display panel is de-energized, it means the display panel stops working. For the convenience of accumulating the subsequent time, the currently accumulated operating time when the display panel is de-energized is determined to be the starting time next time for accumulating the operating time of the display panel when energized.

Step S103, according to the time range corresponding to the accumulated operating time, a corresponding one of the gamma curves is selected. Different time ranges correspond to different gamma curves, so a corresponding one of the gamma curves is selected according to the time range corresponding to the accumulated operating time.

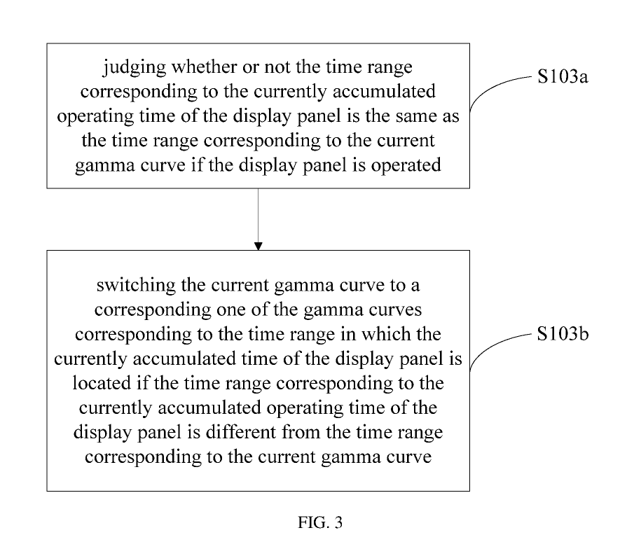

Preferably, FIG. 3 is a sub flow chart of step S103 in FIG. 1. Step S103 specifically includes the following steps of:

Step S103a, if the display panel is operated, it is judged whether or not the time range corresponding to the currently accumulated operating time of the display panel is the same as the time range corresponding to the current gamma curve.

Because the accumulated operating time of the display panel will only be longer and longer, the time range corresponding to the currently accumulated operating time of the display panel is either the same as the time range corresponding to the current gamma curve or different from the time range corresponding to the current gamma curve. When the time range corresponding to the currently accumulated operating time of the display panel is the same as the time range corresponding to the current gamma curve, the current gamma curve will not deviate too much so the current gamma curve is not required to be switched, that is, the aging of the of the display panel has not yet caused much impact on the material properties of the display panel.

Step S103b, if the time range corresponding to the currently accumulated operating time of the display panel is different from the time range corresponding to the current gamma curve, the current gamma curve is switched to a corresponding one of the gamma curves corresponding to the time range in which the currently accumulated time of the display panel is located. When the time range corresponding to the currently accumulated operating time of the display panel is different from the time range corresponding to the current gamma curve, the current gamma curve has deviated. In order to achieve the best display effect of the display panel, it is necessary to switch the current gamma curve timely.

Step S104, according to the selected gamma curve, the operation of the display panel is controlled. When the accumulated operating time reaches a new time range, in order to correct and adjust the original gamma curve of the display panel to avoid dimness and other issues of the display panel caused by the original gamma curve, it is necessary to set the gamma curve corresponding to the new time range as the gamma curve to control the operation of the display panel at this time, so that the display panel can provide the best display effect.

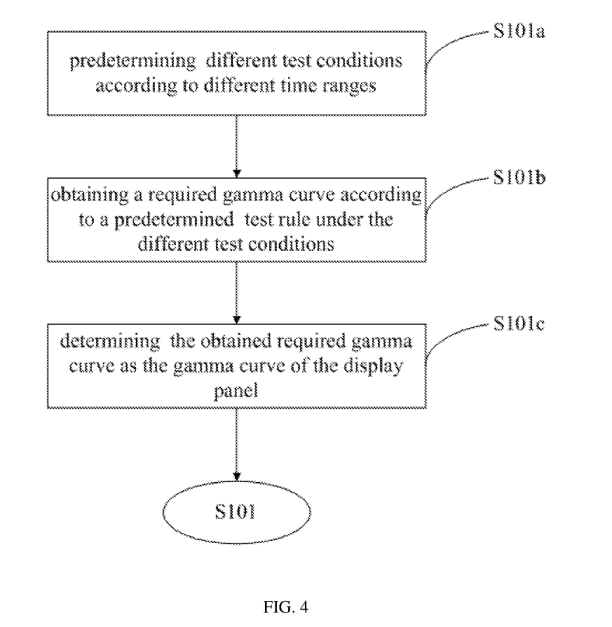

FIG. 4 is a flow chart of a method for correcting and adjusting a gamma curve in accordance with another embodiment of the present invention. The difference between the method shown in FIG. 4 and the method shown in FIG. 1 is that before step S101, the method further comprises the following steps:

Step S101a, according to different time ranges, different test conditions are set. Preferably, the test conditions include temperature and humidity. The other test conditions that may affect the aging of the material of the display panel can be selected according to actual needs. The time ranges include a first time range and a second time range. The test conditions include a first test condition corresponding to the first time range and a second test condition corresponding to the second time range. The first time range is less than the second time range.

Step S101b, under the different test conditions, a required gamma curve is obtained according to a predetermined test rule. Preferably, as set forth in step S101a, the predetermined test rule is that the temperature and humidity values of the first test condition are less than the temperature and humidity values of the second test condition.

Step S101c, the obtained required gamma curve is determined to be the gamma curve of the display panel. The different tests go into sub predetermined test rules to obtain the required gamma curve, and the obtained gamma curve is determined to be the gamma curve of the display panel according to the user's actual needs.

For example, if the display panel is energized for 10 minutes to 15 minutes at a temperature of 60° C. and a humidity of 90%, the degree of aging is equivalent to that of the display panel which is energized in the standard temperature and humidity environment for 4 hours to 8 hours. At this time, the gamma curve of the display panel to be energized for 10 minutes to 15 minutes at a temperature of 60° C. and a humidity 90% can be obtained, and it is taken as the gamma curve of the display panel to be energized in the standard temperature and humidity environment for 4 hours to 8 hours, and it is determined to be one of the gamma curves in the display panel. The gamma curve corresponds to the time range of 4 hours to 8 hours. Similarly, the same method can be used to get the gamma curve corresponding to the time range of 8 hours to 12 hours, and can be followed.

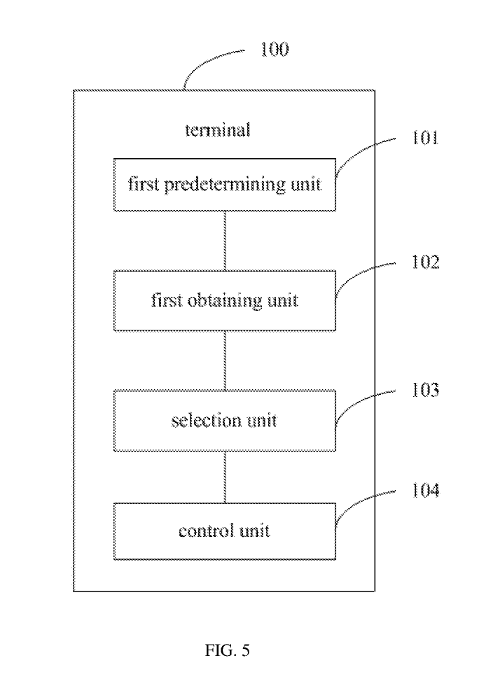

FIG. 5 is a block diagram of a terminal in accordance with an embodiment of the present embodiment. As shown in FIG. 5, the terminal 100 may include a first predetermining unit 101, a first obtaining unit 102, a selection unit 103, and a control unit 104.

The first predetermining unit 101 is used for predetermining a plurality of different gamma curves in a display panel. Each gamma curve corresponds to a time range.

Wherein, because the gamma curve of the display panel will deviate correspondingly over time, in order to ensure the display effect of the display panel, it is necessary to set a plurality of different gamma curves in the display panel and to select a corresponding one of the gamma curves within a specific time range for gamma correction and adjustment.

The first obtaining unit 102 is used for obtaining an accumulated operating time of the display panel.

Wherein, the gamma curves of the display panel are related to the material properties of the display panel. When the material of the display panel is aged, the gamma curve currently applied to the display panel will deviate. The aging speed of the display panel is related to the operating time of the display panel. It is necessary to measure the accumulated operating time of the display panel.

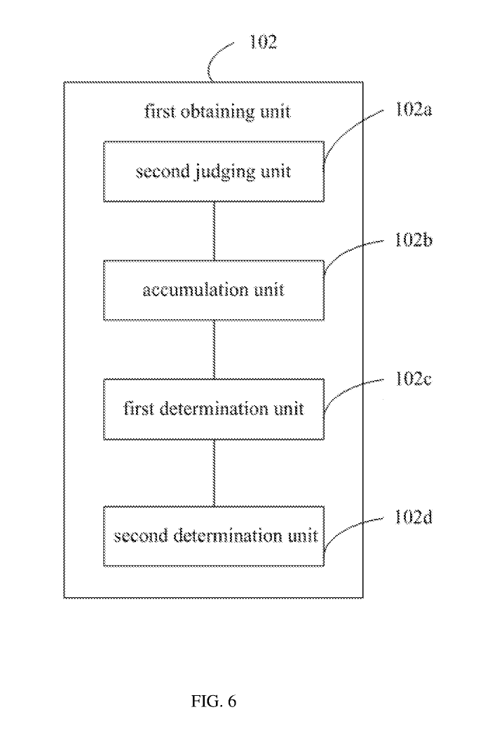

Preferably, FIG. 6 is a sub block diagram of the first obtaining unit 102 of FIG. 5. The first obtaining unit 102 specifically includes a second judging unit 102a, an accumulation unit 102b, a first determination unit 102c, and a second determination unit 102d.

The second judging unit 102a is used for judging whether or not the display panel is energized. The display panel is powered by an external power supply. When the display panel is energized, the display panel is considered to start working.

The accumulation unit 102b is used for accumulating the operating time of the display panel if the display panel is energized. When the display panel is energized to start working, the previous operating time of the display panel is fully accumulated to obtain a total accumulated time.

The first determination unit 102c is used for taking the currently accumulated operating time as the accumulated operating time of the display panel.

The second determination unit 102d is used for taking the currently accumulated operating time as the starting time next time to accumulate the operating time of the display panel if the display panel is de-energized.

Wherein, the aging of the material of the display panel is related to the total operating time of the display panel. When the display panel is de-energized, it means the display panel stops working. For the convenience of accumulating the subsequent time, the currently accumulated operating time when the display panel is de-energized is determined to be the starting time next time for accumulating the operating time of the display panel when energized.

The selection unit 103 is used for selecting a corresponding one of the gamma curves according to the time range corresponding to the accumulated operating time. Different time ranges correspond to different gamma curves, so a corresponding one of the gamma curves is selected according to the time range corresponding to the accumulated operating time.

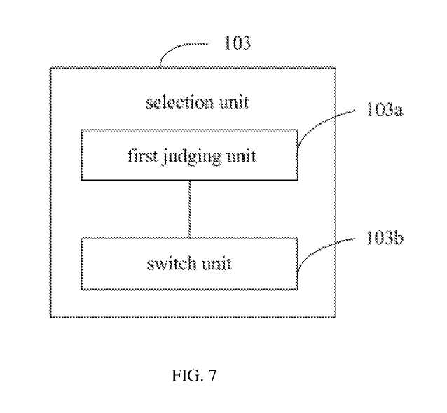

Preferably, FIG. 7 is a sub flow chart of the selection unit 103 of FIG. 5. The selection unit 103 specifically includes a first judging unit 103a and a switch unit 103b.

The first judging unit 103a is used for judging whether or not the time range corresponding to the currently accumulated operating time of the display panel is the same as the time range corresponding to the current gamma curve if the display panel is operated.

Because the accumulated operating time of the display panel will only be longer and longer, the time range corresponding to the currently accumulated operating time of the display panel is either the same as the time range corresponding to the current gamma curve or different from the time range corresponding to the current gamma curve. When the time range corresponding to the currently accumulated operating time of the display panel is the same as the time range corresponding to the current gamma curve, the current gamma curve will not deviate too much so the current gamma curve is not required to be switched, that is, the aging of the of the display panel has not yet caused much impact on the material properties of the display panel.

The switch unit 103b is used for switching the current gamma curve to a corresponding one of the gamma curves corresponding to the time range in which the currently accumulated time of the display panel is located if the time range corresponding to the currently accumulated operating time of the display panel is different from the time range corresponding to the current gamma curve. When the time range corresponding to the currently accumulated operating time of the display panel is different from the time range corresponding to the current gamma curve, the current gamma curve has deviated. In order to achieve the best display effect of the display panel, it is necessary to switch the current gamma curve timely.

The control unit 104 is used for controlling the operation of the display panel according to the selected gamma curve. When the accumulated operating time reaches a new time range, in order to correct and adjust the original gamma curve of the display panel to avoid dimness and other issues of the display panel caused by the original gamma curve, it is necessary to set the gamma curve corresponding to the new time range as the gamma curve to control the operation of the display panel at this time, so that the display panel can provide the best display effect.

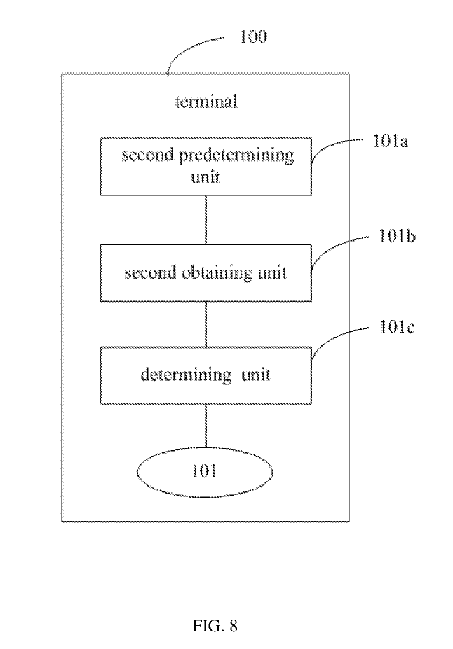

FIG. 8 is a block diagram of a terminal in accordance with another embodiment of the present invention. The difference between the terminal shown in FIG. 5 and the terminal shown in FIG. 8 is that before the first predetermining unit 101, the terminal 100 further comprises a second predetermining unit 101a, a second obtaining unit 101b, and a determining unit 101c.

The second predetermining unit 101a is used for predetermining different test conditions according to different time ranges. Preferably, the test conditions include temperature and humidity. The other test conditions that may affect the aging of the material of the display panel can be selected according to actual needs. The time ranges include a first time range and a second time range. The test conditions include a first test condition corresponding to the first time range and a second test condition corresponding to the second time range. The first time range is less than the second time range.

The second obtaining unit 101b is used for obtaining a required gamma curve according to a predetermined test rule under the different test conditions. Preferably, it is known from the content of step S101a that the temperature and humidity values of the first test condition are less than the temperature and humidity values of the second test condition.

The determining unit 101c is used for determining the obtained required gamma curve as the gamma curve of the display panel. The different tests go into sub predetermined test rules to obtain the required gamma curve, and the obtained gamma curve is determined to be the gamma curve of the display panel according to the user's actual needs.

For example, if the display panel is energized for 10 minutes to 15 minutes at a temperature of 60° C. and a humidity of 90%, the degree of aging is equivalent to that of the display panel which is energized in the standard temperature and humidity environment for 4 hours to 8 hours. At this time, the gamma curve of the display panel to be energized for 10 minutes to 15 minutes at a temperature of 60° C. and a humidity 90% can be obtained, and it is taken as the gamma curve of the display panel to be energized in the standard temperature and humidity environment for 4 hours to 8 hours, and it is determined to be one of the gamma curves in the display panel. The gamma curve corresponds to the time range of 4 hours to 8 hours. Similarly, the same method can be used to get the gamma curve corresponding to the time range of 8 hours to 12 hours, and can be followed.

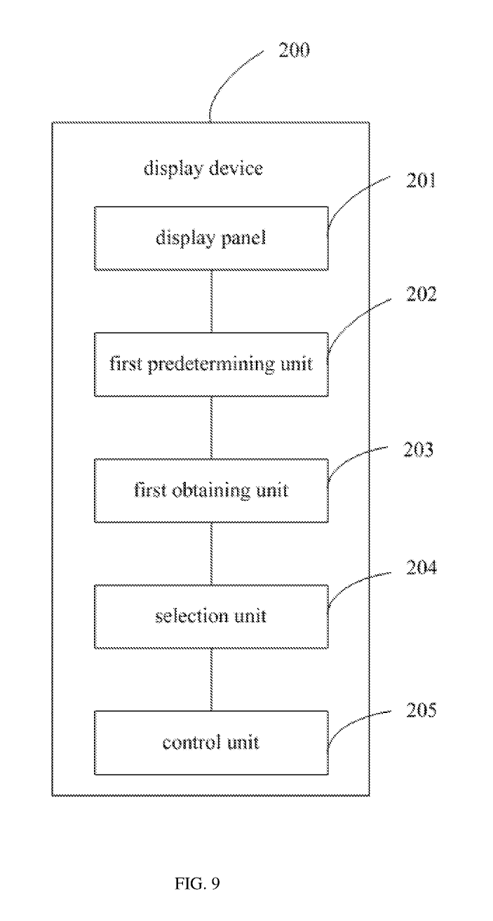

FIG. 9 is a block diagram of a display device in accordance with another embodiment of the present invention. The display device includes a display panel 201. The display panel 201 may be a liquid crystal display panel or other display panel. The display device 200 further includes a first predetermining unit 202, a first obtaining unit 203, a selection unit 204, and a control unit 205.

The first predetermining unit 202 is used for predetermining a plurality of different gamma curves in a display panel. Each gamma curve corresponds to a time range.

The first obtaining unit 203 is used for obtaining an accumulated operating time of the display panel.

The selection unit 204 is used for selecting a corresponding one of the gamma curves according to the time range corresponding to the accumulated operating time. Different time ranges correspond to different gamma curves, so a corresponding one of the gamma curves is selected according to the time range corresponding to the accumulated operating time.

The control unit 205 is used for controlling the operation of the display panel according to the selected gamma curve. When the accumulated operating time reaches a new time range, in order to correct and adjust the original gamma curve of the display panel to avoid dimness and other issues of the display panel caused by the original gamma curve, it is necessary to set the gamma curve corresponding to the new time range as the gamma curve to control the operation of the display panel at this time, so that the display panel can provide the best display effect.

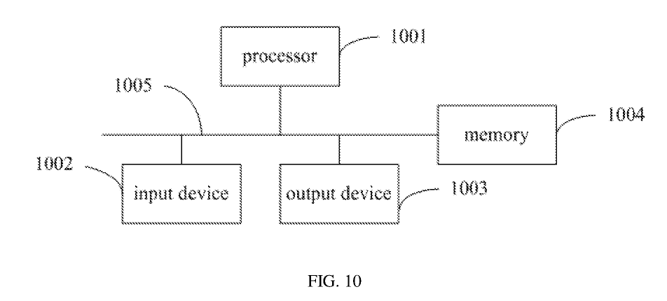

FIG. 10 is a block diagram of a terminal in accordance with another embodiment of the present invention or a display device in accordance with another embodiment. As shown in FIG. 10, the terminal may include one or more processors 1001, one or more input devices 1002, one or more output devices 1003, and a memory 1004. The processor 1001, the input device 1002, the output device 1003, and the memory 1004 are connected via a bus 1005. The memory 1002 is used to store instructions. The processor 1001 is used to execute the instructions stored in the memory 1002.

The processor 1001 is used for predetermining a plurality of different gamma curves in a display panel, each gamma curve corresponding to a time range; obtaining an accumulated operating time of the display panel; selecting a corresponding one of the gamma curves according to the time range corresponding to the accumulated operating time; controlling an the operation of the display panel according to the selected gamma curve.

Furthermore, the processor 1001 is capable of predetermining different test conditions according to different time ranges; obtaining a required gamma curve according to a predetermined test rule under the different test conditions; determining the obtained required gamma curve as the gamma curve of the display panel.

Furthermore, the processor 1001 is capable of judging whether or not the display panel is energized; accumulating the operating time of the display panel if the display panel is energized; taking the currently accumulated operating time as the accumulated operating time of the display panel; determining the currently accumulated operating time as the starting time next time to accumulate the operating time of the display panel if the display panel is de-energized. The processor 1001 is also capable of judging whether or not the time range corresponding to the currently accumulated operating time of the display panel is the same as the time range corresponding to the current gamma curve if the display panel is operated; switching the current gamma curve to a corresponding one of the gamma curves corresponding to the time range in which the currently accumulated time of the display panel is located if the time range corresponding to the currently accumulated operating time of the display panel is different from the time range corresponding to the current gamma curve.

In the embodiments of the present invention, the processor 1001 may be a central processing unit (CPU), which may be other general processor, digital signal processor (DSP), application specific integrated circuit (ASIC), field-programmable gate array (FPGA), or other programmable logic device, discrete gate or transistor logic device, discrete hardware component, and the like. The general processor may be a microprocessor, or the processor may be any conventional processor.

The input devices 1002 may include a touchpad, a fingerprint sensor (for collecting the information of the fingerprint of the user, and the information of the direction of the fingerprint), a microphone, and the like. The output devices 1003 may include a display (LCD, etc.), a speaker, and the like.

The memory 1004 may include a read-only memory and a random access memory and provide instructions and data to the processor 1001. A portion of the memory 1004 may include a non-volatile random access memory. For example, the memory 1004 may store the information about the device.

In a particular implementation, the processor 1001, the input device 1002, and the output device 1003 described in another embodiment of the present may perform the method of correcting and adjusting the gamma curve provided by the embodiments of the present invention and the implementation described in another embodiment. The implementation able to execute the terminal and the display device described in the embodiments of the present invention will not be repeated.

A person skilled in the art can understand that the units and algorithm steps described in the embodiments of the present invention can be implemented by electronic hardware, computer software, or a combination thereof. In order to clearly illustrate the interchangeability of the hardware and software, the assembly and steps of each example have been described in terms of functionality in the above description. These functions implemented by hardware or software depend on the specific application and design constraints of the technical solution. The person skilled in the art may use different methods to implement the described functions for each particular application, but such implementations should not be considered beyond the scope of the present invention.

Those skilled in the art can understand that for convenience and simplicity of description, the specific operating processes of the terminals and units described above may refer to the corresponding processes of the aforesaid methods of the embodiments, and will not be described hereinafter.

In the embodiments of the present invention, it should be understood that the disclosed terminals and methods may be implemented in other ways. For example, the embodiments of the devices described above are merely illustrative. For example, the division of the units is only a logical function division. The actual implementation can be divided by other ways. For example, multiple units or components may be combined or integrated into another system, or some features can be ignored or not executed. In addition, the coupling or direct coupling or communication connection as shown or discussed may be an indirect coupling or a communication connection through some interfaces, devices or units, or may be electrically, mechanically, or otherwise connected.

The steps in the method of the embodiments of the present invention may be adjusted in sequence, combined and deleted according to actual needs.

The units of the terminal of the embodiments of the present invention can be combined, divided and deleted according to actual needs.

The separate units described above may or may not be physically separate. The display components as units may or may not be physical units, i.e., may be located in one place or may be distributed over a plurality of network units. The part or all of the units may be selected according to the actual needs to achieve the embodiments of the present invention.

In addition, the functional units of the various embodiments of the present invention may be integrated in one processing unit, or may be physically separate from each unit. Two or more units may be integrated into one unit. The integrated unit can be implemented by means of hardware or software functional units.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method for correcting and adjusting a gamma curve, comprising:
predetermining a plurality of different gamma curves in a display panel, wherein each of the gamma curves corresponds to a time range;
obtaining an accumulated operating time of the display panel;
selecting a corresponding one of the gamma curves according to the time range corresponding to the accumulated operating time; and
controlling an operation of the display panel according to the selected gamma curve.

2. The method as claimed in claim 1, further comprising:
predetermining different test conditions according to different time ranges;
obtaining a required gamma curve according to a predetermined test rule under the different test conditions; and
determining the obtained required gamma curve to be the gamma curve of the display panel.

3. The method as claimed in claim 2, wherein the test conditions include temperature and humidity, the time ranges include a first time range and a second time range, the test conditions include a first test condition corresponding to the first time range and a second test condition corresponding to the second time range, the first time range is less than the second time range, and the predetermined test rule is that temperature and humidity values of the first test condition are less than temperature and humidity values of the second test condition.

4. The method as claimed in claim 1, the step of obtaining the accumulated operating time of the display panel further comprising:
judging whether or not the display panel is energized;
accumulating the operating time of the display panel if the display panel is energized;
taking the currently accumulated operating time as the accumulated operating time of the display panel; and
taking the currently accumulated operating time as a starting time next time to accumulate the operating time of the display panel if the display panel is de-energized.

5. The method as claimed in claim 2, the step of obtaining the accumulated operating time of the display panel further comprising:
judging whether or not the display panel is energized;
accumulating the operating time of the display panel if the display panel is energized;
taking the currently accumulated operating time as the accumulated operating time of the display panel; and
taking the currently accumulated operating time as a starting time next time to accumulate the operating time of the display panel if the display panel is de-energized.

6. The method as claimed in claim 3, the step of obtaining the accumulated operating time of the display panel further comprising:
judging whether or not the display panel is energized;
accumulating the operating time of the display panel if the display panel is energized;
taking the currently accumulated operating time as the accumulated operating time of the display panel; and
taking the currently accumulated operating time as a starting time next time to accumulate the operating time of the display panel if the display panel is de-energized.

7. The method as claimed in claim 1, the step of selecting a corresponding one of the gamma curves according to the time range corresponding to the accumulated operating time further comprising:
judging whether or not the time range corresponding to the currently accumulated operating time of the display panel is the same as the time range corresponding to the current gamma curve if the display panel is operated; and
switching the current gamma curve to a corresponding one of the gamma curves corresponding to the time range in which the currently accumulated time of the display panel is located if the time range corresponding to the currently accumulated operating time of the display panel is different from the time range corresponding to the current gamma curve.

8. A display device, comprising:
a display panel;
a memory unit, used for storing program instructions; and
a processing unit, connected with the display panel and the memory unit, used for calling and executing the program instructions to perform the following steps: predetermining a plurality of different gamma curves in a display panel, wherein each of the gamma curves corresponds to a time range; obtaining an accumulated operating time of the display panel; selecting a corresponding one of the gamma curves according to the time range corresponding to the accumulated operating time; and controlling an operation of the display panel according to the selected gamma curve.

9. The display device as claimed in claim 8, wherein the processing unit used for calling and executing the program instructions further performs the following steps:
predetermining different test conditions according to different time ranges;
obtaining a required gamma curve according to a predetermined test rule under the different test conditions; and
determining the obtained required gamma curve as the gamma curve of the display panel.

10. The display device as claimed in claim 9, wherein the test conditions include temperature and humidity, the time ranges include a first time range and a second time range, the test conditions include a first test condition corresponding to the first time range and a second test condition corresponding to the second time range, the first time range is less than the second time range, and the predetermined test rule is that temperature and humidity values of the first test condition are less than temperature and humidity values of the second test condition.

11. The display device as claimed in claim 8, wherein when the processing unit performs the step of obtaining the accumulated operating time of the display panel, the processing unit further performs the following steps of:
judging whether or not the display panel is energized;
accumulating the operating time of the display panel if the display panel is energized;
taking the currently accumulated operating time as the accumulated operating time of the display panel; and
taking the currently accumulated operating time as a starting time next time to accumulate the operating time of the display panel if the display panel is de-energized.

12. The display device as claimed in claim 9, wherein when the processing unit performs the step of obtaining the accumulated operating time of the display panel, the processing unit further performs the following steps of:
judging whether or not the display panel is energized;
accumulating the operating time of the display panel if the display panel is energized;
taking the currently accumulated operating time as the accumulated operating time of the display panel; and
taking the currently accumulated operating time as a starting time next time to accumulate the operating time of the display panel if the display panel is de-energized.

13. The display device as claimed in claim 10, wherein when the processing unit performs the step of obtaining the accumulated operating time of the display panel, the processing unit further performs the following steps of:
judging whether or not the display panel is energized;
accumulating the operating time of the display panel if the display panel is energized;
taking the currently accumulated operating time as the accumulated operating time of the display panel; and
taking the currently accumulated operating time as a starting time next time to accumulate the operating time of the display panel if the display panel is de-energized.

14. The display device as claimed in claim 8, wherein when the processing unit performs the step of selecting a corresponding one of the gamma curves according to the time range corresponding to the accumulated operating time, the processing unit further performs the following steps of:
judging whether or not the time range corresponding to the currently accumulated operating time of the display panel is the same as the time range corresponding to the current gamma curve if the display panel is operated; and
switching the current gamma curve to a corresponding one of the gamma curves corresponding to the time range in which the currently accumulated time of the display panel is located if the time range corresponding to the currently accumulated operating time of the display panel is different from the time range corresponding to the current gamma curve.

15. A display device, comprising:
a display panel;
a first predetermining unit, used for predetermining a plurality of different gamma curves in a display panel, wherein each of the gamma curves corresponds to a time range;
a first obtaining unit, used for obtaining an accumulated operating time of the display panel;
a selection unit, used for selecting a corresponding one of the gamma curves according to the time range corresponding to the accumulated operating time; and
a control unit, used for controlling an operation of the display panel according to the selected gamma curve.

16. The display device as claimed in claim 15, further comprising:
a second predetermining unit, used for predetermining different test conditions according to different time ranges;
a second obtaining unit, used for obtaining a required gamma curve according to a predetermined test rule under the different test conditions; and
a determining unit, used for determining the obtained required gamma curve to be the gamma curve of the display panel.

17. The display device as claimed in claim 16, wherein the test conditions include temperature and humidity, the time ranges include a first time range and a second time range, the test conditions include a first test condition corresponding to the first time range and a second test condition corresponding to the second time range, the first time range is less than the second time range, and the predetermined test rule is that temperature and humidity values of the first test condition are less than temperature and humidity values of the second test condition.

18. The display device as claimed in claim 15, wherein the first obtaining unit further comprises:
a second judging unit, used for judging whether or not the display panel is energized;
an accumulation unit, used for accumulating the operating time of the display panel if the display panel is energized;
a first determination unit, used for taking the currently accumulated operating time as the accumulated operating time of the display panel; and
a second determination unit, used for taking the currently accumulated operating time as a starting time next time to accumulate the operating time of the display panel if the display panel is de-energized.

19. The display device as claimed in claim 15, wherein the selection unit comprises:
a first judging unit, used for judging whether or not the time range corresponding to the currently accumulated operating time of the display panel is the same as the time range corresponding to the current gamma curve if the display panel is operated; and
a switch unit, used for switching the current gamma curve to a corresponding one of the gamma curves corresponding to the time range in which the currently accumulated time of the display panel is located if the time range corresponding to the currently accumulated operating time of the display panel is different from the time range corresponding to the current gamma curve.

20. The display device as claimed in claim 17, wherein the selection unit comprises:
a first judging unit, used for judging whether or not the time range corresponding to the currently accumulated operating time of the display panel is the same as the time range corresponding to the current gamma curve if the display panel is operated; and
a switch unit, used for switching the current gamma curve to a corresponding one of the gamma curves corresponding to the time range in which the currently accumulated time of the display panel is located if the time range corresponding to the currently accumulated operating time of the display panel is different from the time range corresponding to the current gamma curve.
